(19) United States
(12) Patent Application Publication
(10) Pub. No.: US 2018/0173419 A1
(43) Pub. Date: Jun. 21, 2018

(54) HYBRID SSD WITH DELTA ENCODING

(71) Applicant: Western Digital Technologies, Inc., Irvine, CA (US)

(72) Inventor: Viacheslav Anatolyevich Dubeyko, San Jose, CA (US)

(21) Appl. No.: 15/387,359

(22) Filed: Dec. 21, 2016

(51) Int. Cl. G06F 3/06

(52) U.S. Cl. CPC G06F 3/061; G06F 3/0655; G06F 3/0688

(57) ABSTRACT

A storage device includes a controller, a first memory device with a first type of non-volatile memory, and a second memory device with a second type of non-volatile memory. The second type of non-volatile memory may be byte-addressable and may exhibit a lower latency for write operations than the first type of non-volatile memory. The controller may be configured to receive, from a host device, a write request that include a data log. The data log may include first data associated with a first logical block address and second data associated with a second logical block address. The controller may also be configured to, responsive to determining that a size of the data is at least a threshold size, store at least a portion of the first data to the first memory device. The controller may also be configured to, responsive to determining that the size of the first data does not satisfy the threshold size, store the data to the second memory device.

### TECHNICAL FIELD

The disclosure generally relates to storage devices, and more particularly, to solid state storage devices.

### BACKGROUND

Solid-state drives (SSDs) may be used in computers when relatively low latency is desired. For example, SSDs may exhibit lower latency, particularly for random reads and writes, than hard disk drives (HDDs). This may allow greater throughput for random reads from and random writes to a SSD compared to a HDD. Additionally, SSDs may utilize multiple, parallel data channels to read from and write to memory devices, which may result in high sequential read and write speeds.

SSDs may utilize non-volatile memory (NVM) devices, such as NAND flash memory devices, which continue to store data without requiring persistent or periodic power supply. NAND flash memory devices may be written many times. However, to reuse a particular NAND flash page, the controller typically erases the particular NAND flash block (e.g., during garbage collection). Erasing NAND flash memory devices many times may cause the flash memory cells to lose their ability to store charge, which reduces or eliminates the ability to write new data to the flash memory cells.

### SUMMARY

In one example, a storage device includes a controller, a first memory device, and a second memory device. The first memory device includes a first type of non-volatile memory and the second memory device includes a second type of non-volatile memory. The second type of non-volatile memory is byte-addressable and exhibits lower latency for read and/or write operations compared to the first type of non-volatile memory. The controller is configured to receive, from a host device, a write request that includes a data log. The data log includes first data associated with a first logical block address and second data associated with a second logical block address. The data log can include many pieces of data and logical block addresses associated with respective pieces of data. The controller is also configured to, responsive to determining that a size of the first data is at least a threshold size, store at least a portion of the data to the first memory device. The controller is further configured to, responsive to determining that the size of the data is less than the threshold size, or is not a multiple of the threshold size, store at least a portion of the first data to the second memory device.

In another example, a method includes receiving, by a controller of a storage device and from a host device, a write request that includes a data log. The data log includes first data associated with a first logical block address and second data associated with a second logical block address. The method includes, responsive to determining that a size of the first data is at least a threshold size, storing, by the controller, at least a portion of the first data to a first memory device of the storage device, where the first memory device includes a first type of non-volatile memory. The method further includes, responsive to determining that the size of the first data is less than the threshold size, storing, by the controller, the data to a second memory device of the storage device, where the second memory device includes a second type of non-volatile memory, and where the second type of non-volatile memory is byte-addressable and exhibits lower latency for write operations than the first type of non-volatile memory.

In another example, a storage device includes means for receiving a write request that includes a data log. The data log includes first data associated with a first logical block address and second data associated with a second logical block address. The storage device includes, responsive to determining that a size of the first data is at least a threshold size, means for storing at least a portion of the first data to a first memory device of the storage device, where the first memory device comprises a first type of non-volatile memory. The storage device further includes, responsive to determining that the size of the first data is less than the threshold size, means for storing the first data to a second memory device of the storage device, where the second memory device comprises a second type of non-volatile memory, and the second type of non-volatile memory is byte-addressable and exhibits lower latency for write operations than the first type of non-volatile memory.

The details of one or more examples are set forth in the accompanying drawings and the description below. Other features, objects, and advantages will be apparent from the description and drawings, and from the claims.

### BRIEF DESCRIPTION OF DRAWINGS

FIG. 1 is a conceptual and schematic block diagram illustrating an example storage environment in which a storage device may function as a storage device for a host device, in accordance with one or more techniques of this disclosure.

FIG. 2 is a conceptual and schematic block diagram illustrating an example controller, in accordance with one or more techniques of this disclosure.

FIG. 3 is a conceptual and schematic block diagram illustrating an example storage environment in which a storage device may perform a write operation, in accordance with one or more techniques of this disclosure.

FIG. 4 is a conceptual and schematic block diagram illustrating an example storage environment in which a storage device may perform a read operation, in accordance with one or more techniques of this disclosure.

FIG. 5 is a flow diagram illustrating example technique for storing data to a storage device, in accordance with one or more techniques of this disclosure.

FIG. 6 is a flow diagram illustrating example technique for storing data to a storage device, in accordance with one or more techniques of this disclosure.

FIG. 7 is a flow diagram illustrating example technique for retrieving data from a storage device, in accordance with one or more techniques of this disclosure.

### DETAILED DESCRIPTION

In general, this disclosure describes techniques for managing read and write operations involving a storage device, such as a solid state drive (SSD). A storage device may include two or more different types of non-volatile memory (NVM) devices. For example, the storage device may include a first type of NVM device (e.g., a NAND flash memory device) and a second, different type of NVM device (e.g., magnetoresistive random-access memory (MRAM)) that is byte-addressable and has a lower read and/or write latency than the first NVM device. In other words, the second NVM device may perform read and/or write operations faster than the first NVM device.

The storage device may include a controller that may manage write operations to, and read operations from, the different types of NVM devices. The controller may receive a single write request that includes first data (e.g., a portion of a data log) and a logical block address (LBA) associated with the first data, as well as a second data (e.g., a different portion of the data log) and an LBA associated with the second data. The first data may include at least one physical sector (or logical block) of data (e.g., 4 kilobytes (KB)) and the second data may include less than a physical sector (or logical block) of data (e.g., 1 KB). For example, the first data may include a logical block of data in an initial state, where the first data is associated with a first LBA. The second data may include less than a logical block of data associated with a second LBA. The second data may include one or more changes to pre-existing data (also referred to as one or more deltas). The controller may write the first data to the flash memory device and may write the second data to the other NVM device.

By writing the first data (e.g., at least one physical sector of data) to the flash memory device and writing the second data (e.g., less than one physical sector of data) to the other NVM device, the controller may reduce the number of write operations to the flash memory device. Reducing the number of write operations to the flash memory device may increase the longevity of the flash memory device. Writing only the updated data (as opposed to re-writing the entire logical block of data), and writing the updated data to the other NVM (which may perform write operations faster than the flash memory devices), may also increase write performance.

When performing read operations, the controller may retrieve data (e.g., at least a physical sector of data) associated with an LBA from the flash memory device and/or data (e.g., less than a physical sector of data) associated with the LBA from another (e.g., non-flash) NVM device. If the controller retrieves data from only the non-flash NVM device during a particular read operation no data is read from the flash memory device for this particular read operation), the controller may improve read performance because the non-flash NVM device has lower latency for read operations relative to flash memory devices. When retrieving data from the flash memory device and data from the non-flash NVM device, the controller may simultaneously retrieve the data from flash memory and non-flash memory. The controller may finish retrieving the data from the non-flash NVM device before finishing retrieving the data from flash memory, and may combine the data with minimal (or no) effect on read performance.

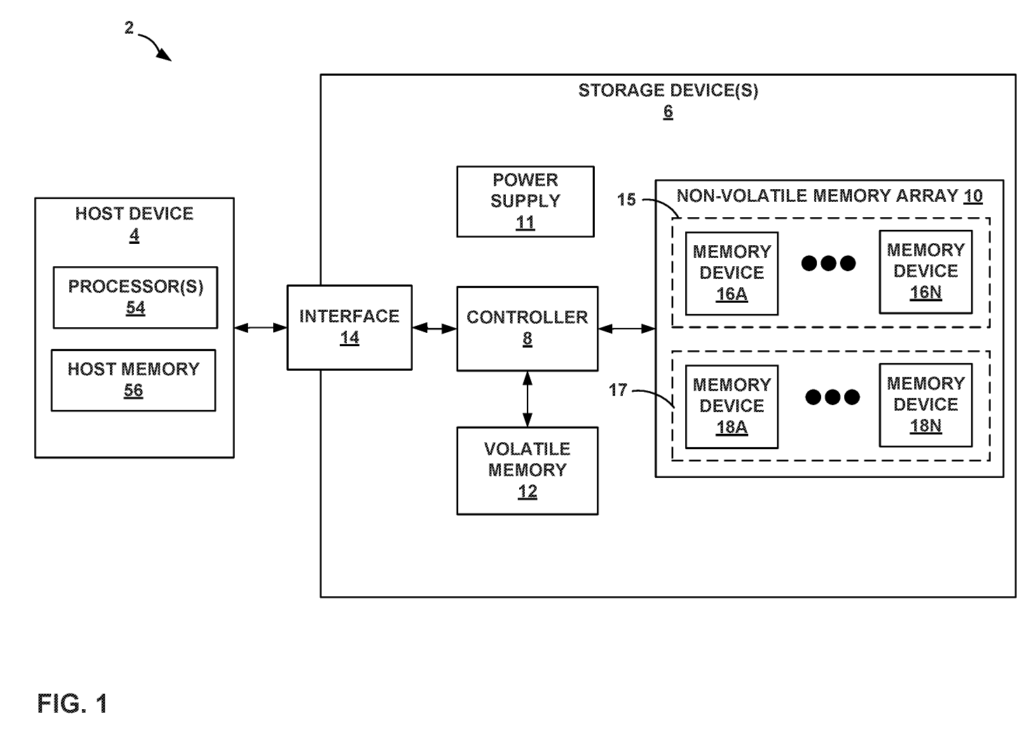

FIG. 1 is a conceptual and schematic block diagram illustrating an example storage environment 2 in which storage device 6 may function as a storage device for host device 4, in accordance with one or more techniques of this disclosure. For instance, host device 4 which may store data to and/or retrieve data from one or more storage devices 6. In some examples, storage environment 2 may include a plurality of storage devices, such as storage device 6, which may operate as a storage array. For instance, storage environment 2 may include a plurality of storages devices 6 configured as a redundant array of inexpensive/independent disks (RAID) that collectively function as a mass storage device for host device 4.

Host device 4 may include any computing device, including, for example, a computer server, a network attached storage (NAS) unit, a desktop computer, a notebook (e.g., laptop) computer, a tablet computer, a set-top box, a mobile computing device such as a “smart” phone, a television, a camera, a display device, a digital media player, a video gaming console, a video streaming device, or the like. Host device 4 may include at least one processor 54 and host memory 56. At least one processor 24 may include any form of hardware capable of processing data and may include a general purpose processing unit (such as a central processing unit (CPU)), dedicated hardware (such as an application specific integrated circuit (ASIC)), configurable hardware (such as a field programmable gate array (FPGA)), or any other form of processing unit configured by way of software instructions, microcode, firmware, or the like. Host memory 56 may be used by host device 4 to store information (e.g., temporarily store information). In some examples, host memory 56 may include volatile memory, such as random-access memory (RAM), dynamic random access memory (DRAM), static RAM (SRAM), and synchronous dynamic RAM (SDRAM (e.g., DDR1, DDR2, DDR3, DDR3L, LPDDR3, DDR4, and the like).

As illustrated in FIG. 1, storage device 6 may include controller 8, non-volatile memory array (NVMA) 10, power supply 11, volatile memory 12, and interface 14. In some examples, storage device 6 may include additional components not shown in FIG. 1 for sake of clarity. For example, storage device 6 may include a printed board (PB) to which components of storage device 6 are mechanically attached and which includes electrically conductive traces that electrically interconnect components of storage device 6, or the like. In some examples, the physical dimensions and connector configurations of storage device 6 may conform to one or more standard form factors. Some example standard form factors include, but are not limited to, 3.5″ data storage device (e.g., an HDD or SSD), 2.5″ data storage device, 1.8″ data storage device, peripheral component interconnect (PCI®), PCI-extended (PCI-X®), PCI Express (PCIe®) (e.g., PCIe® x1, x4, x8, x16, PCIe® Mini Card, MiniPCI®, etc.), M.2, or the like. In some examples, storage device 6 may be directly coupled (e.g., directly soldered) to a motherboard of host device 4.

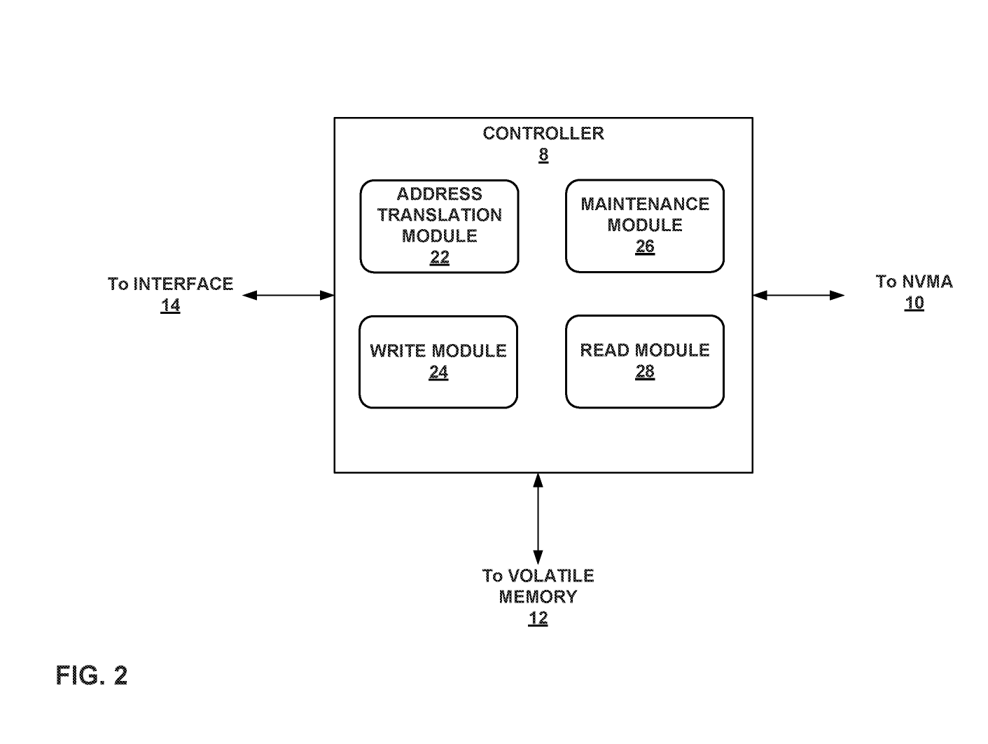

Storage device 6 may include interface 14 for interfacing with host device 4. Interface 14 may include one or both of a data bus for exchanging data with host device 4 and a control bus for exchanging commands with host device 4. Interface 14 may operate in accordance with any suitable protocol. For example, as described in more detail with reference to the examples of FIGS. 2-5, interface 14 may operate according to a serially attached SCSI (SAS) protocol.

However, in other examples, the techniques of this disclosure may apply to an interface 14 that operates in accordance with one or more of the following protocols: advanced technology attachment (ATA) (e.g., serial-ATA (SATA), and parallel-ATA (PATA)), Fibre Channel, small computer system interface (SCSI), Non-Volatile Memory Express (NVMe™), PCI®, PCIe®, or the like. The interface 14 (e.g., the data bus, the control bus, or both) is electrically connected to controller 8, providing a communication channel between host device 4 and controller 8, allowing data to be exchanged between host device 4 and controller 8. In some examples, the electrical connection of interface 14 may also permit storage device 6 to receive power from host device 4.

Storage device 6 may include power supply 11, which may provide power to one or more components of storage device 6. When operating in a standard mode, power supply 11 may provide power to the one or more components using power provided by an external device, such as host device 4. For instance, power supply 11 may provide power to the one or more components using power received from host device 4 via interface 14. In some examples, power supply 11 may include one or more power storage components configured to provide power to the one or more components when operating in a shutdown mode, such as where power ceases to be received from the external device. In this way, power supply 11 may function as an onboard backup power source. Some examples of the one or more power storage components include, but are not limited to, capacitors, super capacitors, batteries, and the like.

Storage device 6 also may include volatile memory 12, which may be used by controller 8 to store information. In some examples, controller 8 may use volatile memory 12 as a cache. For instance, controller 8 may store cached information in volatile memory 12 until the cached information is written to non-volatile memory array 10. Volatile memory 12 may consume power received from power supply 11. Examples of volatile memory 12 include, but are not limited to, random-access memory (RAM), dynamic random access memory (DRAM), static RAM (SRAM), and synchronous dynamic RAM (SDRAM (e.g., DDR1, DDR2, DDR3, DDR3L, LPDDR3, DDR4, and the like).

Storage device 6 includes non-volatile memory array (NVMA) 10, which includes two or more different types of non-volatile memory. For example, NVMA 10 includes a first type of NVM 15 and a second, different type of NVM 17. NVM 15 and NVM 17 may each include a plurality of memory devices. For example, as illustrated in FIG. 1, NVM 15 may include memory devices 16A-16N (collectively, “memory devices 16”) and NVM 17 may include memory devices 18A-18N (collectively, “memory devices 18”). Each of memory devices 16,18 may be configured to store and/or retrieve data. For instance, controller 8 may store data in memory devices 16,18 and may read data from memory devices 16,18. In some examples, each of memory devices 16, 18 may be referred to as a die. In some examples, each memory device 16, 18 may include more than one die. In some examples, a single physical chip may include a plurality of dies (i.e., a plurality of memory devices 16,18). In some examples, each of memory devices 16,18 may be configured to store relatively large amounts of data (e.g., 128 MB, 512 MB, 1 GB, 4 GB, 16 GB, 64 GB, 128 GB, 512 GB, 1 TB, etc.).

Memory devices 16, 18 may each include any type of NVM devices, such as flash memory devices (e.g., NAND or NOR), phase-change memory (PCM) devices, resistive random-access memory (ReRAM) devices, magnetoresistive random-access memory (MRAM) devices, ferroelectric random-access memory (F-RAM), holographic memory devices, and any other type of non-volatile memory devices. Unlike flash memory devices, PCM devices, ReRAM devices, MRAM devices, and F-RAM devices may not require stale block reclamation (e.g., garbage collection), but still may utilize wear leveling to reduce effects of limited write endurance of individual memory cells. In some examples, PCM, ReRAM, MRAM, and F-RAM devices may have better endurance than flash memory devices. In other words, PCM, ReRAM, MRAM, and F-RAM devices may be capable of performing more read and/or write operations before wearing out compared to flash memory devices.

In examples where memory devices 16 of NVM 15 include flash memory devices, each memory device of memory devices 16 may include a plurality of blocks, each block including a plurality of pages. Each block may include 128 KB of data, 256 KB of data, 2 MB of data, 8 MB of data, etc. In some instances, each page may include 1 kilobyte (KB) of data, 4 KB of data, 8 KB of data, etc. Controller 8 may write data to and read data from memory devices 16 at the page level and erase data from memory devices 16 at the block level. In other words, memory devices 16 may be page addressable. In examples where memory devices 18 of NVM 17 include PCM, ReRAM, MRAM, F-RAM, or similar non-flash NVM devices, each memory device of memory devices 18 may be byte addressable. In other words, controller 8 may write to memory devices 18 in units of a byte and may write to memory devices 16 in units of a page.

Storage device 6 includes controller 8, which may manage one or more operations of storage device 6. For instance, controller 8 may manage the reading of data from and/or the writing of data to NVMA 10. Controller 8 may represent one of or a combination of one or more of a microprocessor, digital signal processor (DSP), application specific integrated circuit (ASIC), field programmable gate array (FPGA), or other digital logic circuitry.

In accordance with techniques of this disclosure, controller 8 may manage writes to, and reads from, different types of non-volatile memory devices within NVMA 10. In some examples, NVMA 10 includes a first type of NVM 15 and a second, different type of NVM 17. NVM 15 and NVM 17 may each include a plurality of memory devices. For example, as illustrated in FIG. 1, NVM 15 includes memory devices 16 and NVM 17 includes memory devices 18.

NVM 15 may perform slow read and/or write operations relative to NVM 17. In other words, NVM 17 may exhibit lower latency for read operations and/or write operations compared to NVM 15. For example, memory devices 16 of NVM 15 may include flash memory devices (e.g., NAND or NOR), which may, in some examples, have read latencies in the tens of microseconds (μs) and write latencies in the hundreds of μs. For instance, the read latency for memory devices 16 may be between approximately 20 μs and approximately 30 μs and the write latency for memory device 16 may be between approximately 100 μs and approximately 500 μs.

In contrast, memory devices 18 may, in some instances, have read latencies in the nanoseconds (ns). As one example, the read latency for memory devices 18 may be between approximately 3 ns and approximately 60 ns. The write latency, in this example, for memory devices 18 may be between approximately 10 ns and approximately 1 μs. Examples of memory devices 18 of NVM 17 capable of providing such read and write latencies may include phase-change memory (PCM) devices, resistive random-access memory (ReRAM) devices, magnetoresistive random-access memory (MRAM) devices, ferroelectric random-access memory (F-RAM), or any other type of memory device that has a lower read and/or write latency compared to memory devices 16.

In some examples, NVM 17 may have better endurance than NVM 15. In other words, NVM 17 may be capable of performing more read and/or write operations before becoming unable to reliably store and retrieve data compared to NVM 15. NVM 15 may also utilize stale block reclamation (e.g., garbage collection) and wear leveling, while NVM 17 may not need to utilize garbage collection but may still utilize wear leveling to reduce effects of limited write endurance of individual memory cells.

Each memory device of memory devices 16 and 18 may include a plurality of blocks, each block including a plurality of pages, and each page including a plurality of bytes. In some examples, the internal architecture of memory devices 18 of NVM 17 may be similar to the internal architecture of volatile memory (e.g., DRAM). In some instances, each page may include 1 kilobyte (KB) of data, 4 KB of data, 8 KB of data, etc. In some examples (e.g., where memory devices 16 of NVM 15 include flash memory devices), controller 8 may write data to and read data from memory devices 16 at the page level and erase data from memory devices 16 at the block level. In other words, memory devices 16 may be page addressable. In some examples (e.g., where memory devices 18 of NVM 17 include PCM, ReRAM, MRAM, F-RAM, or other non-flash NVM devices), each memory device of memory devices 18 may be byte addressable. In other words, controller 8 may write to memory devices 18 in units of a byte and may write to memory devices 16 in units of a page.

In operation, controller 8 may receive a write request from host device 4 and may determine where to store the data included in the write request. The write request may include a data log that includes metadata and a data payload. The data payload may include data associated with one or more LBAs. In some instances, the data payload may be divided into a number of separate units, referred to herein as “sections.” For instance, a first section of the data payload may include a quantity of data (e.g., a logical block, two logical blocks, etc.), also referred to herein as a data block. In some instances, a second section of the data payload may include one or more changes, also referred to as deltas, to one or more data blocks. The one or more deltas may represent a change to an initial or previous state of the data block. While the payload is described as including a first section of data and a second section of data, it is to be understood that the payload may include additional data blocks associated with other LBAs and/or additional deltas associated with other LBAs.

In some examples, the metadata includes a size of the data log (e.g., a number of bytes) and a number of sections (also referred to as portions of data) in the data payload. The metadata may also include a cyclic redundancy check (CRC) of the data log. In some instances, the metadata indicates a logical block address (LBA) associated with each respective section and a size of each respective section (e.g., a number of bytes). The metadata may also include a flag for each section in the data payload, which may indicate whether the section is compressed.

In response to receiving a data log, controller 8 may determine an NVM device (e.g., NVM 15 or NVM 17) to store the data included in the data log. In some examples, controller 8 may determine an NVM device to store each section of data the data payload based on the size of each section of data. For example, controller 8 may parse the metadata associated with each section of data in the data log to determine the size of each section of data.

Controller 8 may determine whether a size of a particular section of data satisfies a threshold size. In some instances, controller 8 may determine that the size of the section satisfies the threshold size if the section of data is at least equal to the threshold size. The threshold size may be a logical block (or physical sector) of data. If the size of the first section is less than the threshold size, controller 8 may store the section of data to memory devices 18 of NVM 17. For example, if the section of data includes a 1 KB delta and the threshold size equals 4 KB, controller 8 may determine the delta does not satisfy the threshold size and may store the delta to memory devices 18 of NVM 17.

In response to determining that the section of data satisfies the threshold size, controller 8 may store at least a portion of the section of data to memory devices 16 of NVM 15. In some examples, controller 8 may store data from the first section to memory devices 16 in increments equal to the threshold size. For example, if the threshold size equals 4 KB and the section of data equals 4 KB of data, controller 8 may store the entire section to memory devices 16 of NVM 15. If the section of data includes 10 KB of data, controller 8 may extract 8 KB of data from the section and may store the extracted portion of the section to memory devices 16. In such an example, controller 8 may store the remaining 2 KB to memory device 18 of NVM 17. In some instances, controller 8 may store the entire first section of data to memory device 16 of NVM 15 in response to determining the size of the first section satisfies the threshold size.

Because memory devices 18 of NVM 17 may be addressable in relatively small units (e.g., bytes) compared to memory devices 16 of NVM 15 (e.g., which may be addressable in units of a page), writing the deltas to memory devices 18 may utilize the overall memory space of storage device 6 more efficiently than writing the deltas to memory devices 16. In some storage devices, re-writing a single page of data to a page addressable memory devices 15 may involve writing the page to a new physical location, updating (e.g., by a flash-translation layer) a mapping between the logical address and the new physical location, and marking the old pages as stale, which may eventually require erasing an entire block (e.g., performing garbage collection) to re-use the old pages. In contrast, in the techniques described in this disclosure, controller 8 may store a change to a single byte of data by writing the deltas to memory devices 18. As a result, controller 8 may store updates to data stored at NVMA 10 in smaller data units while also potentially reducing the number of writes and erasures performed on NVM 15.

In this manner, controller 8 may store at least a portion of each section of a data log that satisfies a threshold size to NVM 15 and may store each section of the data log that does not satisfy the threshold size to NVM 17. Because writes to NVM 17 may take less time than writes to NVM 15 (e.g., NVM 17 may exhibit a lower write latency than NVM 15), writing the deltas to NVM 17 may improve the speed of a write operation. Further, writing the deltas to NVM 17 may reduce the number of write operations performed at NVM 15, which increase the longevity of NVM 15.

FIG. 2 is a conceptual and schematic block diagram illustrating example details of controller 8. In some examples, controller 8 may include one or more address translation modules 22, one or more write modules 24, one or more maintenance modules 26, and one or more read modules 28. In other examples, controller 8 may include additional modules or hardware units, or may include fewer modules or hardware units. Controller 8 may include various types of digital logic circuitry, such as any combination of one or more microprocessors, one or more digital signal processors (DSPs), one or more application specific integrated circuits (ASICs), one or more field programmable gate arrays (FPGAs), or other types of digital logic circuitry.

Controller 8 of storage device 6 (e.g., as shown in FIG. 1) may interface with the host device 4 of FIG. 1 via interface 14 and manage the storage of data to and the retrieval of data from memory devices 16 and 18 of NVMA 10 of FIG. 1. For example, one or more write module 24 of controller 8 may manage writes to memory devices 16 and 18. In some examples, controller 8 may include one or more write modules 24 that may write data to different memory devices. For instance, a first write module 24 may write data to memory devices 16 and a second write module 24 may write data to memory devices 18. For purposes of illustration only, controller 8 is described as including a single write module 24. For instance, write module 24 may receive a write request that includes a data log from host device 4 via interface 14 and may manage writing of the data block(s) and/or delta(s) in the data log to memory devices 16 and 18.

Write module 24 may communicate with one or more address translation modules 22, which manages translation between logical addresses (LBAs) used by host device 4 to manage storage locations of data and physical addresses used by write module 24 to direct writing of data to memory devices 16 and 18. In some examples, controller 8 may include one or more address translation modules 22. For instance, a first address translation module 22 may be associated with memory devices 16 and a second address translation module 22 may be associated with memory devices 18. For purposes of illustration only, controller 8 is described as including a single address translation module 22. Address translation module 22 of controller 8 may utilize an indirection table, also referred to as a mapping table, that translates logical addresses (or logical block addresses) of data stored by memory devices 16 and 18 to physical addresses of data stored by memory devices 16 and 18. For example, host device 4 may utilize the logical block addresses of the data stored by memory devices 16 and 18 in instructions or messages to storage device 6, while write module 24 utilizes physical addresses of the data to control writing of data to memory devices 16 and 18. (Similarly, read module 28 may utilize physical addresses to control reading of data from memory devices 16 and 18.) The physical addresses correspond to actual, physical locations of memory devices 16 and 18. In some examples, address translation module 22 may store the indirection table in volatile memory 12 and periodically store a copy of the indirection table to memory devices 16 and/or 18.

In this way, host device 4 may use a static logical block address for a certain set of data, while the physical address at which the data is actually stored may change. Address translation module 22 may maintain the indirection table to map the logical block addresses to physical addresses to allow use of the static logical block address by the host device 4 while the physical address of the data may change, e.g., due to wear leveling, garbage collection, or the like.

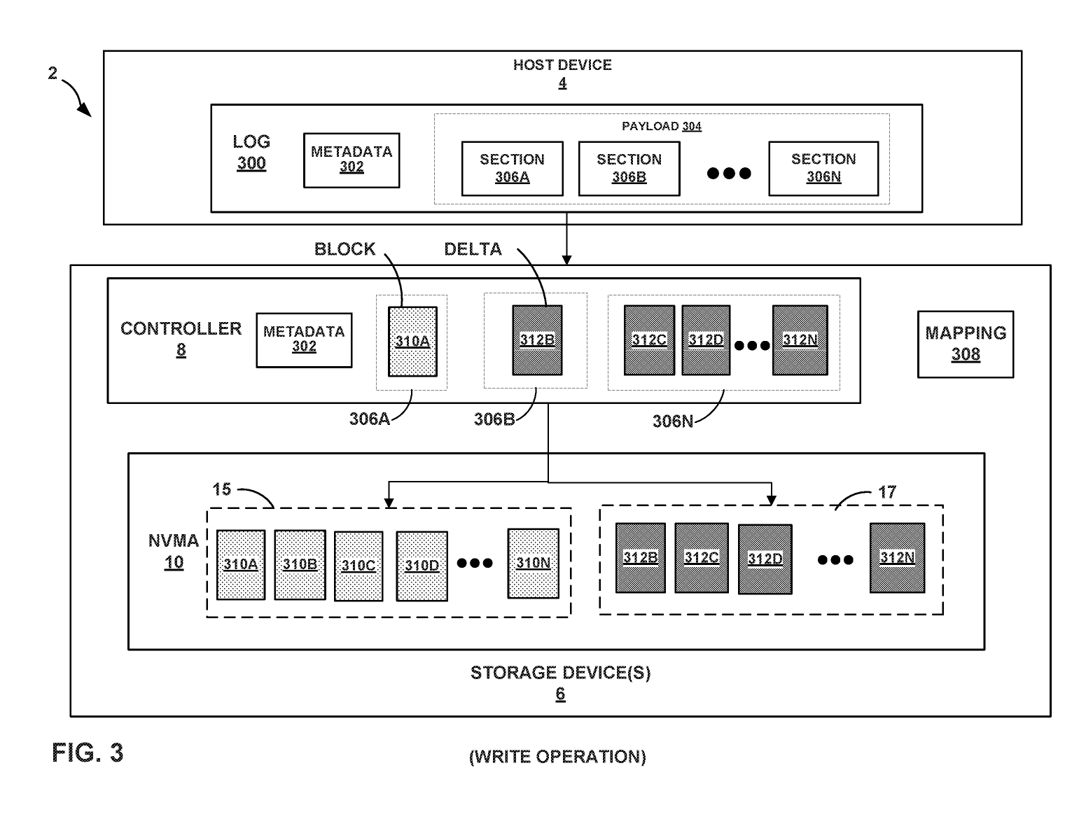

As described in more detail with reference to FIG. 3, write module 24 of controller 8 may perform one or more operations to manage the writing of data to memory devices 16 and/or 18 in response to write requests. For example, write module 24 may manage the writing of data to memory devices 16 and/or 18 by selecting physical locations within memory devices 16 and/or 18 to store the data specified in the write request. As discussed above, write module 24 may interface with address translation module 22 to update the mapping table based on the selected physical locations.

For instance, write module 24 may receive a message from host device 4 that includes a data log, which includes at least one section of data and a logical block address associated with the section of data. Write module 24 may next determine a physical location of memory devices 16 and/or 18 to store the data, and interface with the particular physical location of memory devices 16 and/or 18 to actually store the data. Write module 24 may then interface with address translation module 22 to update the mapping table to indicate that the logical block address corresponds to the selected physical location(s) within the memory devices 16 and/or 18.

Read module 28 similarly may control reading of data from memory devices 16 and/or 18 in response to a read request. In some examples, controller 8 may include one or more read modules 28 that may read data from different memory devices. For instance, a first read module 28 may read data from memory devices 16 and a second read module 28 may read data from memory devices 18. For purposes of illustration only, controller 8 is described as including a single read module 28. For example, read module 28 may receive a read request or other message from host device 4 requesting data with an associated logical address. Read module 28 may interface with address translation module 22 to convert the logical address to a physical addresses using the mapping table. Read module 28 may then retrieve the data from the physical addresses provided by address translation module 22.

Maintenance module 26 may represent a module configured to perform operations related to maintaining performance and extending the useful life of storage device 6 (e.g., memory devices 16 and 18). For example, maintenance module 26 may implement at least one of wear leveling or garbage collection techniques.

FIG. 3 is a conceptual diagram illustrating example storage environment 2 in which a storage device 6 may perform a write operation, in accordance with one or more techniques of this disclosure. FIG. 3 illustrates and describes conceptual and functional elements of FIGS. 1 and 2, with concurrent reference to the physical components illustrated in FIGS. 1 and 2.

Host device 4 may store data in host memory 56. When sending data from host memory 56 to storage device 6 as part of a write request, host device 4 may generate a data log 300. In some examples, host device 4 may generate a data log by a block layer subsystem or by the file system. Log 300 may include metadata 302 and a data payload 304. Payload 304 may include a plurality of data sections 306A, 306B, and 306N (collectively, “sections 306”). As described with reference to FIG. 1, in some examples, each section 306 may include a data block, one or more deltas, or a combination therein. Metadata 302 of each log entry 302 may include one or more LBAs associated with the respective payload 306. Similarly, metadata 302 may indicate the size of each portion of data (e.g., each data block or delta) in each section 306 and a logical address associated with each portion of data in each section 306.

Storage device 6 of FIG. 1 may receive a write request that includes log 300 and may store the log 300 in volatile memory 12. As illustrated in FIG. 3, section 306A includes data block 310A, section 306B includes delta 312B associated with data block 310B (which may have been previously stored to memory device 15), and section 306N includes a plurality of deltas 312C-312N associated with data blocks 310C-310N (which may have been previously stored to memory device 15). Controller 8 may determine, for each portion of data in the respective sections 306, whether the size of each portion of data (e.g., each data block or delta) in the section 306 satisfies (e.g., is greater than or equal to) a threshold size (e.g., one physical sector or logical block). For instance, write module 24 of FIG. 2 may parse metadata 302 after log 300 is stored in the volatile memory 12 to determine whether each data block 310 and/or delta 312 (e.g., stored in volatile memory 12) satisfies the threshold size. As illustrated in FIG. 3, by parsing metadata 302, write module 24 may determine that data block 310A satisfies the threshold size, and each delta of deltas 3112B-312N does not satisfy the threshold size.

After storing data log 300 to volatile memory 12, write module 24 may determine an NVM device (e.g., NVM 15 or NVM 17) to store the data received as part of data log 300. For example, write module 24 may store some of the data in log 300 to a first type of NVM device (e.g., NMV 15) and may store other data in log 300 to a second type of NVM device (e.g., NVM 17) that is byte addressable. In some instances, the second type of NVM device exhibits lower read and/or write latencies relative to the first type of NVM device. In response to determining that data block 310A is at least equal to the threshold size, write module 24 may store at least a portion of data block 310A NVM 15. In some examples, write module 24 may store data to NVM 15 in increments of the threshold size. In other words, in some instances, if the threshold size equals 4 KB and data block 310A includes 6 KB of data, write module 24 may store 4 KB from data block 310A to NVM 15 and may store the remaining 2 KB from data block 310A to NVM 17. In some examples, write module 24 may store all of data block 310A to NVM 15 in response to determining the data block is at least equal to the threshold size. Either way, address translation module 22 may select a physical location of NVM 15 to store at least a portion of the data and write module 24 may store the data at the respective physical locations of NVM 15.

Similarly, write module 24 may determine that a some of data of log 300 does not satisfy the threshold size. For example, write module 24 may determine, based on metadata 302, that delta 312B of section 306B does not satisfy a threshold size and that each of deltas 312C-312N does not satisfy the threshold size. In response to determining that each delta of deltas 312B-312N do not satisfy the threshold size, write module 24 may store the deltas 312 to NVM 17. For instance, address translation module 22 may determine the physical locations of NVM 17 to store deltas 312, and write module 24 may cause the NVM 17 to store the deltas 312 at the particular physical locations associated with each respective delta 312.

Storage device 6 may include one or more mapping tables used to track the physical locations at which data is stored. For instance, address translation module 22 may manage mapping table 308 to translate between logical addresses used by host device 4 and physical address used to actually store data blocks 310 at NVM 15. Mapping table 308 may be stored in volatile memory 12 and may also be stored in persistent memory (e.g., NVM 15, and/or NVM 17).

Address translation module 22 may also utilize mapping table 308 to map data blocks 310 to the corresponding deltas 312. In some examples, mapping table 308 may associate, for each delta 312 stored at NVM 17, a respective physical address of NVM 17 at which the delta 312 is stored and an address of NVM 15 that corresponds to each delta 312. In other words, for each delta 312, mapping table 308 may indicate the respective physical byte address of NVM 17 at which a particular delta 312 is stored. Similarly, for each delta 312, mapping table 308 may indicate a respective logical and/or physical address of a data block 310 associated with each delta 312. For instance, mapping table 308 may map the physical byte address of NVM 17 for each delta 312 to a logical block address associated with the respective delta 312.

In some examples, in response to determining a physical location at which to store each respective delta of deltas 312, address translation module 22 may update mapping table 308 to indicate the physical byte address of NVM 17 at which each delta 312 is stored. Address translation module 22 may also update mapping table 308 to include a logical block address associated with each delta 312 and/or a physical byte address of NVM 15 associated with each respective delta 312. For example, as illustrated in Table 1, address translation module 22 may update mapping table 308 in response to determining a physical location of NVM 17 to store each respective delta 312. For instance, address translation module 22 may determine to store delta 312B at byte address 0x000F of NVM 17, and address translation module 22 may update mapping table 308 to indicate that delta 312B is associated with LBA 310B and is stored at byte address 0x0000F of NVM 17. Similarly, address translation module 22 may update mapping table 22 to include the physical byte address for each delta 312 and write module 24 may store each delta at the respective physical byte address.

TABLE 1

| Delta ID | Delta Byte Address | Data Block | Data Block LBA |
|---|---|---|---|
| 312B | 0x0000F | 310B | 0x00001 |
| 312C | 0x00010 | 310C | 0x00002 |
| 312D | 0x00011 | 310D | 0x00003 |

Controller 8 may perform a merge operation to merge data blocks 310 and one or more deltas 312 to generate one or more updated data blocks. In some examples, maintenance module 26 of controller 8 may perform a merge operation in response to performing garbage collection and/or wear leveling operation or in response to determining that a bit error rate (BER) is greater than a threshold BER. For example, while performing a garbage collection operation, maintenance module 26 may merge deltas 312 within NVM 17 with the respective corresponding data blocks 310. For instance, maintenance module 26 may merge block 310B and delta 312B to generate an updated data block 310B′, block 310C and delta 312C to generate an updated data block 310C′, and so on. In some examples, maintenance module 26 may merge a subset of deltas 312 and the corresponding data blocks 310. For example, if storage device 6 stores snapshots of different states of a logical block, maintenance module 26 may move a data block (e.g., 310B) without merging the data block 310B with the corresponding delta 312B.

Maintenance module 26 of controller 8 may perform a merge operation in response to determining that the number of deltas 312 satisfies a threshold number of deltas. In some instance, maintenance module 26 may compare the number of deltas 312 associated with a particular data block 310 to a first threshold number of deltas. Maintenance module 26 may alternatively or additionally compare the total number of deltas 312 in NVM 17 to a second threshold number of deltas. In other words, maintenance module 26 may compare the number of deltas 312 associated with a particular data block 310 to one threshold, and/or may compare the total number of deltas 312 in NVM 17 to a different threshold. In some instances, maintenance module 26 may determine whether the number of deltas 312 satisfies a threshold in response to initiating a garbage collection or wear leveling operation, in response to determining that a BER satisfies a threshold BER, or in response to determining that controller 8 is idle (e.g., is not performing a read or write operation). In some examples, maintenance module 26 may periodically determine whether the number of deltas 312 satisfies a threshold. For example, maintenance module 26 may compare the number of deltas 312 to a threshold number of deltas every time a write request is received, after a threshold number of write requests, every time a read request is received, after a threshold number read requests, or at regular time intervals (e.g., once per hour, day, week, month, etc.).

Maintenance module 26 may query mapping table 308 to determine how many deltas are included in NVM 17 and/or how many deltas in NVM 17 are associated with each data block in NVM 15. Maintenance module 26 may determine that NVM 17 includes X number of deltas (where X is any integer) and may compare the number of deltas 312 to a threshold number of deltas (e.g., 10, 50, 250, or any other number). For example, maintenance module 26 may determine that the number of deltas 312 associated with a particular data block 310 satisfies the first threshold number (e.g., 5) of deltas. As another example, if the second threshold number of deltas equals 150 (e.g., the threshold number for all deltas in NVM 17 equals 150) and maintenance module 26 determines that the total number of deltas in NVM 17 equals 200, maintenance module 26 may determine the total number of deltas satisfies the threshold because the total number of deltas is greater than the second threshold. If maintenance module 26 determines that either the first or second threshold is satisfied, maintenance module 8 may perform a merge operation.

In some examples, maintenance module 26 may perform a merge operation by retrieving one or more data blocks 310 from NVM 15, one or more deltas 312 associated with data blocks 310 from NVM 17, storing data blocks 310 and deltas 312 to volatile memory 12 or NVMA 10, and combining the data block and respective deltas into an updated data block. For instance, maintenance module 26 may query mapping table 308 to determine the physical addresses of MAI 17 used to store each of deltas 312, may query a mapping table 308 to determine the physical addresses of NVM 15 used to store the data blocks 310 associated with each delta 312, and may retrieve deltas 312 and the respective data blocks 310 from NVM 17 and 15, respectively. Maintenance module 26 may combine each data block 310 with the respective deltas 312 to generate an updated data block 310′. In response to generating updated data block 310′, maintenance module 26 may write the updated data blocks 310′ to NVM 15 (e.g., to a different physical location) and may update mapping table 308 to indicate that there are no longer any deltas associated with updated data blocks 310′. For example, maintenance module 26 may delete the deltas 312 from NVM 17 or may mark the deltas 312 as stale. In some examples, maintenance module 26 may delete the data stored at the physical addresses of NVM 17 used to store deltas 312 or may mark the data as stale, such that write module 22 may reuse the physical addresses to store additional deltas 312.

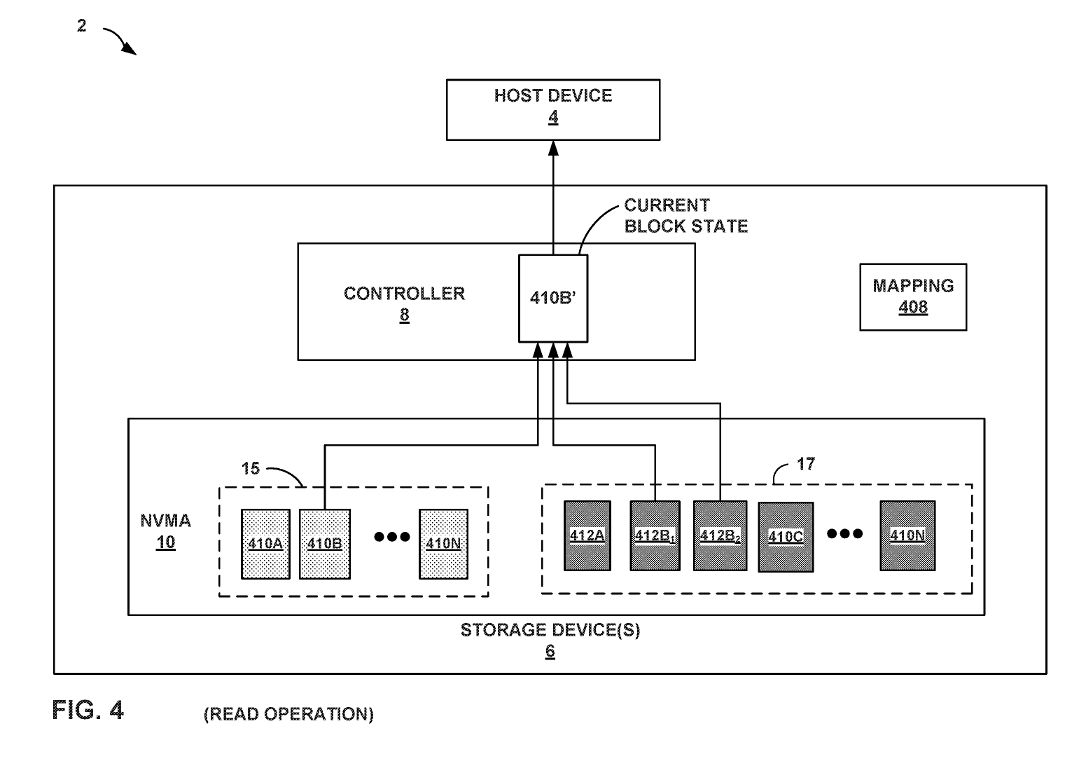

FIG. 4 is a conceptual and schematic block diagram illustrating an example storage environment in which a storage device may perform a read operation, in accordance with one or more techniques of this disclosure. FIG. 4 illustrates and describes conceptual and functional elements of FIGS. 1 and 2, with concurrent reference to the physical components illustrated in FIGS. 1 and 2.

Controller 8 of storage device 2 may receive, from host device 4, a read request to retrieve data associated with a particular LBA. In response to receiving the read request, address translation module 22 may query a mapping table 408 to translate the particular LISA to a physical address at which a particular data block is stored. Similarly, address translation module 22 may query mapping table 408 to determine whether there are any deltas associated with the particular data block and if so, to determine the physical addresses at which the corresponding deltas 412 are stored. For instance, the read request may include a request to retrieve data from an LBA associated with data block 410B. Address translation module 22 may determine a physical address at which data block 410B is stored and the physical addresses at which deltas 412B₁-412B₂ are stored. Read module 28 may retrieve data block 410B from NVM 15 and deltas 412B from NVM 17.

In response to retrieving data block 410B and deltas 412B, read module 28 of controller 8 may merge the data block 410B and deltas 412B to form a current data block 410B′. In some instances, the read module 28 may also receive metadata that describes how to apply deltas 412B to data block 410B. The metadata may be stored at storage device 6 (e.g., within volatile memory 12) or may be received from host device 4 as part of the read request. Read module 28 may load data block 410B and deltas 412B into a temporary memory (e.g., volatile memory 12 of FIG. 1) and may update, within the temporary memory, data block 410B with the deltas 412B. In other words, current data block 410B′ may represent the current state of data block 410 after updating the data block to include the changes represented by deltas 412B. After updating data block 410B within the temporary memory to generate current state of data block 410B′, read module 28 may output current state of data block 410B′ to host device 4. In this way, controller 8 may respond to the read request from host device 4 by sending a current copy of the data associated with the particular LISA even though storage device 6 does not necessarily include all of the most recent data at the same physical location.

In some examples, read module 28 may retrieve data from only NVM 17 in response to receiving a read request. For example, host device 4 may request a small file (e.g., 1 KB of data) that was previously stored to NVM 17 (e.g., because the size of the file is less than the threshold size). Because, in this example, read module 28 only needs to retrieve data from NVM 17, read module 28 may retrieve the data faster that if read module 28 retrieved data from NVM 15 and NVM 17. As a result, in some instances, techniques of this disclosure may improve read performance.

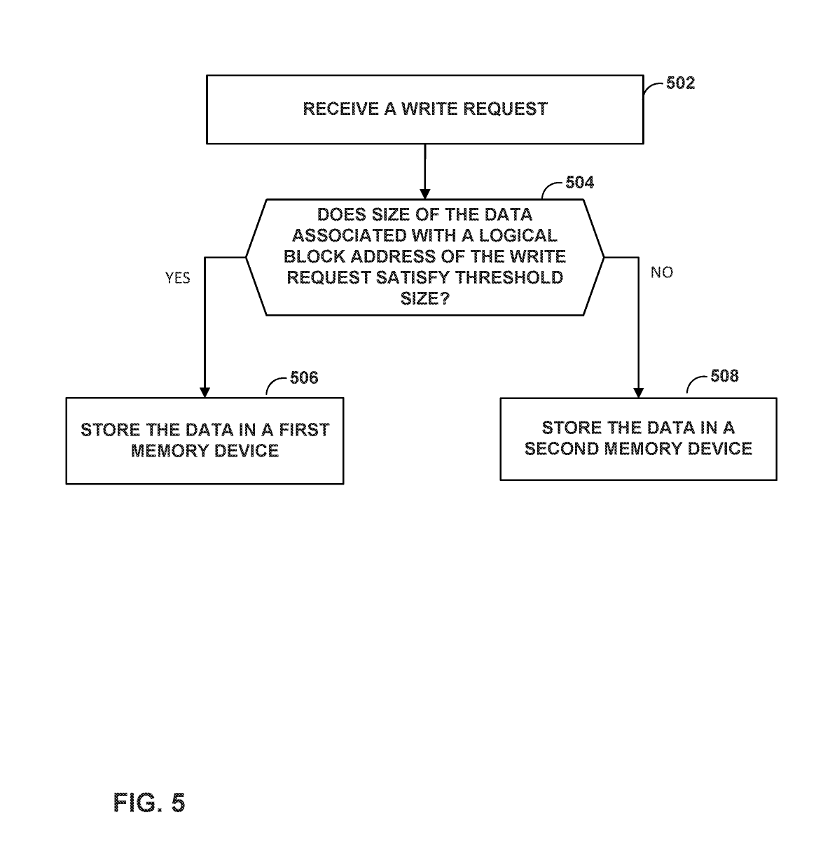

FIG. 5 is a flow diagram illustrating an example technique for storing data to a storage device, in accordance with one or more techniques of this disclosure. For ease of illustration, the technique of FIG. 5 will be described with concurrent reference to storage device 6 of FIGS. 1-2. However, the techniques may be used with any combination of hardware or software.

Controller 8 of storage device 6 may receive a write request from host device 4 (502). The write request may include a data log 300 that includes one or more sections of data and a particular logical block address associated with each respective section of data. The data associated with a logical block address may include a data block 310, one or more deltas 312 to a data block, or both. In some examples, the data log 300 may also include metadata 302 that indicates a size of the data associated with the logical block address. In some instances, metadata 302 may indicate an offset from the beginning of a logical block. Controller 8 may store the data log in a temporary memory of storage device 6 (e.g., volatile memory 12).

Controller 8 may determine whether the size of the data associated with the logical block address satisfies a threshold size (504). Controller 8 may determine the size of data by parsing metadata 302 of log 300 within volatile memory 12. For instance, metadata 302 may indicate the size of data that is associated with a respective logical block address. In some instances, the threshold size equals a physical sector of data.

In response to determining that the size of the data associated with the logical block address satisfies a threshold size (“Yes” decision of block 504), controller 8 may store at least a portion of the data to a first NVM device 15 of storage device 6 (506). For example, controller 8 may store the data associated with the logical block address to the first NVM device 15. For instance, controller 8 may store data in increments of the threshold size, such that, if the data equals 9 KB of data and the threshold size equals 4 KB, controller 8 may store 8 KB of data to first memory device 15 and may store the remaining 1 KB of data to the second NVM device 17. In some examples, controller 8 may store an entire amount of data (e.g., a logical block) to NVM device 15 in response to determining that a particular data block satisfies the threshold size.

In response to determining that the size of the data associated with the logical block address does not satisfy the threshold size (“NO” decision of block 504), controller 8 may store the data to a second NVM device 17 of storage device 6 (508). For instance, controller 8 store the data to the second NVM device 17. In some examples, the second NVM 17 may be byte-addressable and may exhibit lower latencies for write operations than the first NVM 15, For instance, NVM 15 may include a flash (NAND or NOR) memory device and NVM 17 may include a PCM device, ReRAM device, MRAM device, or F-RAM device.

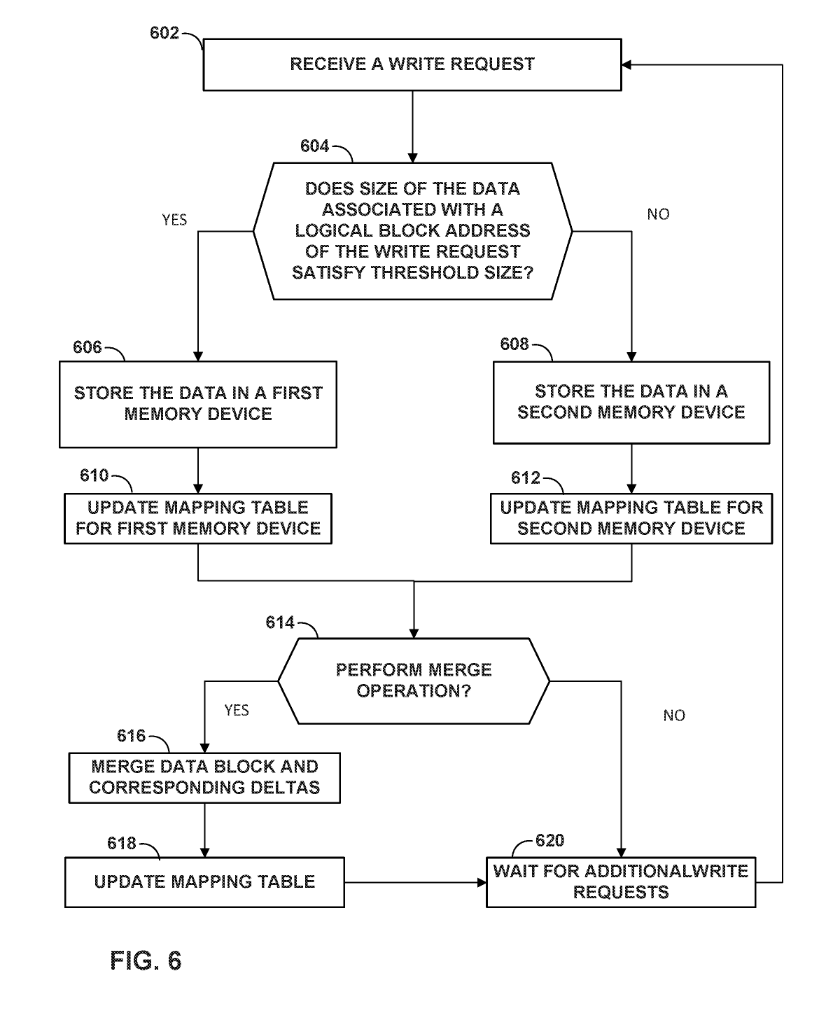

FIG. 6 is a flow diagram illustrating an example technique for storing data to a storage device, in accordance with one or more techniques of this disclosure. For ease of illustration, the technique of FIG. 6 will be described with concurrent reference to storage device 6 of FIGS. 1-3. However, the techniques may be used with any combination of hardware or software.

Controller 8 of storage device 6 may receive a write request from host device 4 (602). The write request may include a data log 300 that includes one or more sections of data and a logical block address associated with each respective section of data. The data associated with the logical block address may include a data block 310, one or more deltas 312 to a data block, or both. In some examples, the data log 300 may also include metadata. 302, which may indicate a size of the data associated with the logical block address.

Controller 8 may determine whether the size of the data associated with the logical block address satisfies a threshold size (604). Controller 8 may determine the size of data by parsing metadata 302 of log 300 within volatile memory 12. For instance, metadata 302 may indicate the size of data that is associated with a respective logical block address. In some instances, the threshold size equals a physical sector of data.

In some examples, the data associated with the logical block address may include a data block 310. The size of a data block 310 may be greater than or equal to a physical sector of data. In response to determining that the size of the data associated with the logical block address satisfies (e.g., is greater than or equal to) a threshold size (“Yes” decision of block 604), controller 8 may store at least a portion of the data in a first NVM device 15. For instance, controller 8 may store data in increments of the threshold size, such that, if the data equals 9 KB of data and the threshold size equals 4 KB, controller 8 may store 8 KB of data to first memory device 15 and may store the remaining 1 KB of data to the second NVM device 17. For instance, controller 8 may determine a physical location within a first NVM device 15 to store a first portion of the data (e.g., 8 KB) and may write the data associated with the particular logical block address at the physical location of the first NVM device 15 of storage device 6 (606). In some instance, controller 8 may store a second portion of the data (e.g., the remaining 1 KB) to second NVM device 17. The first NVM device 15 may be a NAND flash memory device. The first NVM device 15 may be page-addressable. In response to determining a physical location of NVM 15 at which to store the data, controller 8 may update a mapping table to indicate the physical page address of NVM 15 at which the data is located (610).

In some examples, the data associated with the logical block address may include a delta 312. A delta 312 may be as small as one byte. In response to determining that the size of the data associated with the logical block address does not satisfy a threshold size (“No” decision of block 604), controller 8 may store the data in a second NVM device 17. For instance, controller 8 may determine a physical location of the second NVM device 17 to store the data. In response to determining the physical location of the second NVM device 17, controller 8 may store the data associated with the particular logical block address to the physical location. In some examples, the second NVM 17 may be byte-addressable. The second. NVM 17 may exhibit a lower latency for write operations than the first NVM 15. For instance, NVM 16 may include a flash (NAND or NOR) memory device and NVM 17 may include a PCM device, ReRAM device, MRAM device, or F-RAM device. In response to determining a physical location of NVM 17 at which to store the data, controller 8 may update a mapping table 308 to indicate the physical byte address of NVM 17 at which the data is located (612).

Controller 8 may determine whether to perform a merge operation to merge one or more deltas 312 stored at the second memory device with a corresponding data block 310 stored at the first memory device (614). For example, controller 8 may determine whether the number of deltas 312 stored at the second memory device satisfies (e.g., is greater than or equal to) a threshold number of deltas. In some instances, controller 8 may query mapping table 308 to determine the number of deltas 312 for one logical block. Controller 8 may determine to perform a merge operation if the number of deltas (e.g., the total number of deltas in NVM 17 or the number of deltas for one logical block) is greater than the threshold number of deltas. Controller 8 may, in some examples, determine to perform a merge operation upon initiating a garbage collection operation or a wear leveling operation. In another example, controller 8 may determine to perform a merge operation if a BER of the first NVM device 15 and/or second NVM device 17 is equal to greater than a threshold HER. In some examples, in response to determining not to perform a merge operation (614, “NO” path), controller 8 may wait to receive a subsequent read or write request from host device 4 (620).

In response to determining to perform a merge operation (614, “YES” path), controller 8 may perform a merge operation by merging each delta 312 with a respective data block 310 that is associated with the same logical block address as the delta 312 (616). For example, controller 8 may combine data block 310A and delta 312A to generate an updated data block 310A′, combine data block 310B and delta 312B to generate an updated data block 310B′, and so on. In response to generating the updated data blocks, controller 8 may write each updated data block 310′ to NVM 1.5. In some instances, controller 8 may, in response to writing updated data blocks 310′, delete deltas 312N or may mark deltas 312N as stale.

Controller 8 may, in response to merging data block 310N and deltas 312, may update mapping table 308 (618). For instance, controller 8 may update mapping table 308 to indicate that there are no longer any deltas 312 associated with the updated data blocks 310′ and to indicate the new physical location of data blocks 310′. For example, controller 8 may delete the entries of mapping table 308 that are associated with deltas 312 or may mark the entries as stale. In response to updating mapping table 308, controller 8 may wait to receive additional write requests from host device 4 (620). Host device 4 may send another write request and controller 8 may receive the write request (602).

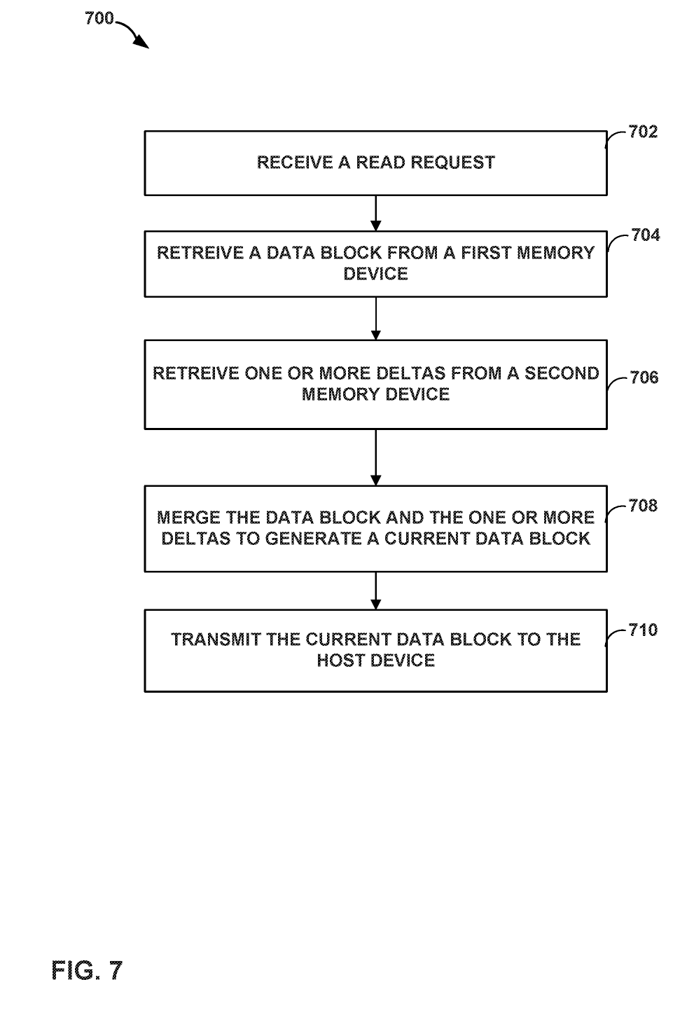

FIG. 7 is a flow diagram illustrating an example technique for retrieving data from a storage device, in accordance with one or more techniques of this disclosure. For ease of illustration, the technique of FIG. 7 will be described with concurrent reference to storage device 6 of FIGS. 1-4. However, the techniques may be used with any combination of hardware or software.

Controller 8 of storage device 2 may receive, from host device 4, a read request to retrieve data associated with a particular LBA (702). For instance, the read request may include a request to retrieve data from a particular LBA, such as an LBA associated with data block 410B.

In some examples, controller 8 may retrieve a data block associated with the particular LBA from a first memory device (704). For example, address translation module 22 of controller 8 may query an indirection table to translate the particular LBA to a physical address at which a particular data block is stored. In response to determining the physical address at which the data block is stored, read module 28 may retrieve the data block from NVM 15 and may store the data block in a temporary memory (e.g., volatile memory 12).

Controller 8 may retrieve one or more deltas associated with the particular LBA from a second memory device (706). For instance, address translation module 22 may query mapping table 408 to determine whether there are any deltas associated with the particular data block and to determine the physical addresses at which the corresponding deltas 412 are stored. In response to determining the physical addresses at which deltas 412B₁-412B₂ are stored, read module 28 may retrieve data block 410B from NVM 15 and deltas 412B from NVM 17 and may store deltas 412B in the temporary memory. Controller 8 may retrieve the one or more deltas from the second memory device at the same time controller 8 retrieves a data block from the first memory device.

In response to retrieving data block 410B and deltas 412B, read module 28 of controller 8 may merge the data block 410B and deltas 412B to form a current data block 410B′ (708). For instance, read module 28 may update, within the temporary memory, data block 410B with deltas 412B. In other words, read module 28 may generate a current data block 410B′ that represents the current state of data block 410 after updating the data block to include the changes represented by deltas 412B.

After generating current data block 410B′, read module 28 may output current data block 410B′ to host device 4 (710). In this way, controller 8 may respond to the read request from host device 4 by sending a current copy of the data block associated with the particular LBA.

The techniques described in this disclosure may be implemented, at least in part, in hardware, software, firmware, or any combination thereof. For example, various aspects of the described techniques may be implemented within one or more processors, including one or more microprocessors, digital signal processors (DSPs), application specific integrated circuits (ASICs), field programmable gate arrays (FPGAs), or any other equivalent integrated or discrete logic circuitry, as well as any combinations of such components. The term “processor” or “processing circuitry” may generally refer to any of the foregoing logic circuitry, alone or in combination with other logic circuitry, or any other equivalent circuitry. A control unit including hardware may also perform one or more of the techniques of this disclosure.

Such hardware, software, and firmware may be implemented within the same device or within separate devices to support the various techniques described in this disclosure. In addition, any of the described units, modules or components may be implemented together or separately as discrete but interoperable logic devices. Depiction of different features as modules or units is intended to highlight different functional aspects and does not necessarily imply that such modules or units must be realized by separate hardware, firmware, or software components. Rather, functionality associated with one or more modules or units may be performed by separate hardware, firmware, or software components, or integrated within common or separate hardware, firmware, or software components.

The techniques described in this disclosure may also be embodied or encoded in an article of manufacture including a computer-readable storage medium encoded with instructions. Instructions embedded or encoded in an article of manufacture including a computer-readable storage medium encoded, may cause one or more programmable processors, or other processors, to implement one or more of the techniques described herein, such as when instructions included or encoded in the computer-readable storage medium are executed by the one or more processors. Computer readable storage media may include random access memory (RAM), read only memory (ROM), programmable read only memory (PROM), erasable programmable read only memory (EPROM), electronically erasable programmable read only memory (EEPROM), flash memory, a hard disk, a compact disc ROM (CD-ROM), a floppy disk, a cassette, magnetic media, optical media, or other computer readable media. In some examples, an article of manufacture may include one or more computer-readable storage media.

In some examples, a computer-readable storage medium may include a non-transitory medium. The term “non-transitory” may indicate that the storage medium is not embodied in a carrier wave or a propagated signal. In certain examples, a non-transitory storage medium may store data that can, over time, change (e.g., in RAM or cache).

Various examples have been described. These and other examples are within the scope of the following claims.

1. A storage device comprising:
a first memory device comprising a first type of non-volatile memory;
a second memory device comprising a second type of non-volatile memory, wherein the second type of non-volatile memory exhibits lower latency for write operations than the first type of non-volatile memory, and wherein the second type of non-volatile memory is byte-addressable; and
a controller configured to:
receive, from a host device, a write request comprising a data log, the data log comprising first data associated with a first logical block address and second data associated with a second logical block address;
responsive to determining that a size of the first data is at least a threshold size, store at least a portion of the first data to the first memory device; and
responsive to determining that a size of the first data is less than the threshold size, store the data to the second memory device.

2. The storage device of claim 1, wherein the first data comprises a first portion of data and a second portion of data, wherein storing at least a portion of the data to the first memory device comprises storing the first portion of data to the first memory device, and wherein the controller is further configured to:
responsive to determining that the size of the first data is greater than the threshold size and the size of the first data is not equal to a multiple of the threshold size, store the second portion of the first data to the second memory device.

3. The storage device of claim 1, wherein the threshold size equals a size of a physical sector or a size of a logical block of data.

4. The storage device of claim 1, wherein the controller is further configured to:
receive, from the host device, a read request to retrieve data associated with a particular logical block address;
retrieve, from the first memory device, based on the particular logical block address, a data block;
retrieve, from the second memory device, based on the particular logical block address, a set of one or more deltas associated with the data block;
merge the data block with the set of one or more deltas to generate a current data block corresponding to a current state of the data block; and
transmit, to the host device, the current data block as a response to the read request.

5. The storage device of claim 1, wherein the storage device further comprises:
one or more data blocks stored at the first memory device;
one or more deltas stored at the second memory device, wherein each delta of the one or more deltas corresponds to a respective data block of the one or more data blocks;
at least one mapping table, wherein the at least one mapping table indicates a physical location of the second memory device at which each respective delta is stored and a logical block address associated with each respective delta, and wherein the at least one mapping table indicates a physical location of the first memory device at which each respective data block is stored and a logical block address associated with each respective data block,
wherein the controller is further configured to perform a merge operation by at least being configured to:
retrieve, from the first memory device, a particular data block;
retrieve, from the second memory device, a particular delta associated with the particular data block;
merge the particular data block and the particular delta to generate an updated data block;
store the updated data block in the first memory device; and
update the mapping table to indicate that the delta is no longer associated with the updated data block.

6. The storage device of claim 5, wherein the controller is further configured to:
determine whether a number of deltas in the second memory device satisfies a threshold value,
wherein the controller is configured to perform the merge operation in response to determining the number of deltas is greater than or equal to the threshold value.

7. The storage device of claim 5, wherein the controller is configured to perform the merge operation in response to initiating a garbage collection or wear leveling operation.

8. The storage device of claim 5, wherein the controller is configured to perform the merge operation in response to determining that a bit error rate associated with the particular data block is greater than or equal to a threshold bit error rate.

9. The storage device of claim 5, wherein the controller is configured to periodically perform the merge operation.

10. The storage device of claim 1, wherein the first type of non-volatile memory comprises a NAND flash memory device, and the second type of non-volatile memory is selected from the group consisting of phase-change memory (PCM), magnetoresistive random access memory (MRAM), or resistive random access memory (ReRAM).

11. A method comprising:
receiving, by a controller of a storage device and from a host device, a write request comprising a data log, wherein the data log comprises first data associated with a first logical block address and second data associated with a second logical block address;
responsive to determining that a size of the first data is at least a threshold size, storing, by the controller, at least a portion of the first data to a first memory device of the storage device, wherein the first memory device comprises a first type of non-volatile memory; and
responsive to determining that the size of the first data is less than the threshold size, storing, by the controller, the first data to a second memory device of the storage device, wherein the second memory device comprises a second type of non-volatile memory, wherein the second type of non-volatile memory exhibiting lower latency for write operations than the first type of non-volatile memory, and wherein the second type of non-volatile memory is byte-addressable.

12. The method of claim 11, wherein the first data comprises a first portion of data and a second portion of data, wherein storing at least a portion of the data to the first memory device comprises storing the first portion of data to the first memory device, and the method further comprising:
responsive to determining that the size of the first data is greater than the threshold size and the size of the first data is not equal to a multiple of the threshold size, storing, by the controller, the second portion of the first data to the second memory device.

13. The method of claim 11, wherein the threshold size equals a size of a physical sector or a size of a logical block of data.

14. The method of claim 11, further comprising:
receiving, by the controller and from the host device, a read request to retrieve data associated with a particular logical block address;
retrieving, by the controller and from the first memory device, based on the particular logical block address, a data block;
retrieving, by the controller and from the second memory device, a set of one or more deltas associated with the data block;
merging, by the controller, the data block with the set of one or more deltas to generate a current data block corresponding to a current state of the data block; and
transmitting, by the controller and to the host device, the current data block as a response to the read request.

15. The method of claim 11, further comprising performing a merge operation by:
retrieving, by the controller and from the first memory device, a data block;
retrieving, by the controller and from the second memory device, a set of one or more deltas associated with the data block;
merging, by the controller, the data block and the set of one or more deltas to generate an updated data block;
storing, by the controller, the updated data block in the first memory device; and
updating, by the controller, at least one mapping table, wherein the at least one mapping table indicates a physical location of the second memory device at which each respective delta of the set of one or more deltas is stored and a logical address of a data block associated with each respective delta, and wherein the at least one mapping table indicates a physical location of the first memory device at which each respective data block is stored and a logical block address associated with each respective data block,
wherein updating the mapping table comprises updating the mapping table to indicate that there are no deltas associated with the updated data block.

16. The method of claim 15, further comprising:
determining, by the controller, whether a number of deltas in the second memory device is greater than or equal to a threshold value,
wherein performing the merge operation comprises performing the merge operation in response to determining, by the controller, that the number of deltas is greater than or equal to the threshold value.

17. The method of claim 15, wherein performing the merge operation comprises performing the merge operation in response to initiating, by the controller, a garbage collection or wear leveling operation.

18. (canceled)

18. The method of claim 10, wherein the first type of non-volatile memory comprises a NAND flash memory device, and the second type of non-volatile memory is selected from the group consisting of phase-change memory (PCM), magnetoresistive random access memory (MRAM), or resistive random access memory (ReRAM).

19. A storage device comprising:
means for receiving a write request comprising a data log, wherein the data log comprises first data associated with a first logical block and second data associated with a second logical block;
responsive to determining that a size of the first data is at least a threshold size, means for storing at least a portion of the first data to a first memory device of the storage device, wherein the first memory device comprises a first type of non-volatile memory; and
responsive to determining that the size of the first data is less than the threshold size, means for storing the first data to a second memory device of the storage device, wherein the second memory device comprises a second type of non-volatile memory, wherein the second type of non-volatile memory exhibits lower latency for write operations than the first type of non-volatile memory, and wherein the second type of non-volatile memory is byte-addressable.

20. The storage device of claim 19, wherein the first data comprises a first portion of data and a second portion of data, wherein storing at least a portion of the data to the first memory device comprises storing the first portion of data to the first memory device, and wherein the storage device further comprises:
responsive to determining that the size of the first data is greater than the threshold size and the size of the first data is not equal to a multiple of the threshold size, means for storing the second portion of the first data to the second memory device.

21. The method of claim 15, wherein performing the merge operation comprises periodically performing the merge operation.
